(19) United States
(12) Patent Application Publication
(10) Pub. No.: US 2004/0135462 A1
(43) Pub. Date: Jul. 15, 2004

(54) Spindle motor

(76) Inventor: Ogura Masayuki, Isezaki-shi (JP)

Correspondence Address: JORDAN AND HAMBURG LLP, 122 EAST 42ND STREET, SUITE 4000, NEW YORK, NY, 10168, US

(21) Appl. No.: 10/744,393

(22) Filed: Dec. 23, 2003

(30) Foreign Application Priority Data
Dec. 25, 2002 (JP) 2002-373549

(51) Int. Cl. H02K 7/00; H02K 11/00; H02K 5/16; H02K 7/08

(52) U.S. Cl. 310/261; 310/67 R; 310/90; 360/99.08; 360/98.07

(57) ABSTRACT

When a stator and a rotor have to be separated for whatever reason after the motor provided with a locking structure has been assembled, the separation can be conducted without breaking the rotor or the motor body. The rotor includes a rotor yoke fixed to the rotor shaft and a disk positioning portion and a disk carrying portion provided at the rotor yoke. It is further provided with a hook extending toward the stator from the insertion hole opened in the rotor yoke, the hook being formed integrally with the disk positioning portion and disk carrying portion or separately therefrom. The mating catch formed at the distal end of the hook and the latching portion formed at the stator are engaged in a contactless manner and operations can be conducted so as to deform the hook elastically from the outside through the insertion hole.

### BACKGROUND OF THE INVENTION

1. Field of the Invention

The present invention relates to a structure of a spindle motor employed, for example, for driving disk media, more specifically to a spindle motor having a locking structure that prevents a rotor from coming out of a stator.

2. Description of the Prior Art

Brushless motors of an outer rotor type have been used as spindle motors for driving disk media.

In order to use a brushless motor as a spindle motor, a configuration is employed in which a rotor is the so-called outer rotor and a disk carrying portion is provided directly at the rotor.

Such spindle motors are typically provided with a locking structure in order to prevent a rotor from coming out of a stator.

Furthermore, a configuration in which a turntable produced by machining a free cutting metal such as brass or the like is integrated with a rotor obtained by press forming a sheet-like magnetic body, or a configuration in which a turntable formed by resin molding is fixed to the rotary shaft of a motor and the rotor is integrated with the turntable are employed for the disk carrying portion.

Japanese Patent Application Laid-open No. 11-86427 describes an example of a configuration having a locking structure in which a rotor is integrated with a disk carrying portion. This configuration will be explained below with reference to FIG. 8.

A rotor holding jig 11 made from resin and having formed therein a boss 11a which is to be engaged with a disk central hole is press fit and fixed to a spindle 8, and a rotor yoke 9 produced from a galvanized steel sheet is adhesively bonded on the outer periphery of the rotor holding jig 11. A disk surface 11b is formed below the boss 11a and a turntable 12 made from a SUS material is mounted thereupon.

At the rear surface of the disk surface 11b, a rotor locking portion 11c is provided concentrically with a projection 3 provided in the stator core 1, and the rotor is prevented from coming out by engagement with the projection 3.

Other open publications disclosing such a configuration include Japanese Patent Applications Laid-open Nos. 11-110897, 10-285858, and 2002-176742.

In a spindle motor having a rotor integrated with such a turntable, the rotor holding jig 11 made from resin and the spindle 8 are press fit and fixed, and the rotor locking structure is constituted by the rotor locking portion 11c formed integrally with the rotor holding jig 11.

In order to prevent the rotor from coming out in the axial direction, the rotor locking portion 11c is provided in a protruding condition, but without contact with the projection 3. Therefore, when the rotor has to be separated from the stator, for example, in the case of a defective motor, the rotor must be pulled forcibly by taking off the protrusion.

With such forcible pulling, the distal end of the locking portion 11c is sometimes broken or the projection 3 is broken.

If the distal end of the locking portion 11c is broken, the rotor holding jig 11 serving as the main component of the rotor becomes unusable and the rotor itself cannot be used anymore. Furthermore, when the projection 3 is broken, the stator (or the motor body) cannot be used.

### SUMMARY OF THE INVENTION

It is an object of the present invention to provide a reusable motor such that when a stator and a rotor have to be separated for whatever reason after the motor has been assembled, the separation can be conducted without breaking the rotor or the motor body and they can be reused.

In order to resolve the above-described problems, the present invention provides a spindle motor in which a disk carrying portion is provided at a rotor of a brushless motor composed of a stator and the rotor, wherein the rotor is provided with a rotor yoke supported rotatably at the stator with a rotary shaft and a disk positioning portion and a disk carrying portion provided at the rotor yoke, and is further provided with a hook extending toward the stator from the insertion hole opened in the rotor yoke, the hook being formed integrally with the disk positioning portion and disk carrying portion or separately therefrom. The mating catch formed at the distal end of the hook and the latching portion formed at the stator are not in contact but can be engaged, and operations can be conducted so as to temporarily deform the hook elastically from the outside through the insertion hole.

With such a configuration, when the rotor has to be separated form the stator, the mating catch and the latching portion are disengaged by elastically temporarily deforming the hook, and the rotor is easily separated. Further, because the hook deformation is within the elastic limit, the hook is not broken and the separated rotor can be reused.

Further, in accordance with the present invention, the operation of elastically deforming the hook can be facilitated by tilting the distal end side of the hook at the prescribed inclination angle toward the rotary shaft, or by providing the hook with a protrusion for this operation.

In accordance with the present invention, when a rotor and a stator in a motor provided with a locking structure have to be separated, they can be separated easily. Furthermore, the separated rotor is not broken and can be reused.

Moreover, a variety of hook configurations to effect separation of the rotor and the stator.

### BRIEF DESCRIPTION OF THE DRAWINGS

FIG. 1 is a side sectional view of the main components illustrating an embodiment of the spindle motor in accordance with the present invention.

FIG. 2 is a sectional view illustrating another embodiment of the main components in accordance with the present invention.

FIG. 3 is a sectional view illustrating yet another embodiment of the main components in accordance with the present invention.

FIG. 4 is a view as shown by an arrow A in FIG. 3.

FIG. 5 is a side sectional view of the main components illustrating an embodiment of the present invention based on another configuration of the embodiment shown in FIG. 1.

FIG. 6 is a side sectional view of the main components illustrating an embodiment of the present invention based on yet another configuration.

FIG. 7 is a side sectional view of the main components illustrating an embodiment of the present invention based on another configuration of the embodiment shown in FIG. 6.

FIG. 8 is a side sectional view illustrating a conventional locking structure.

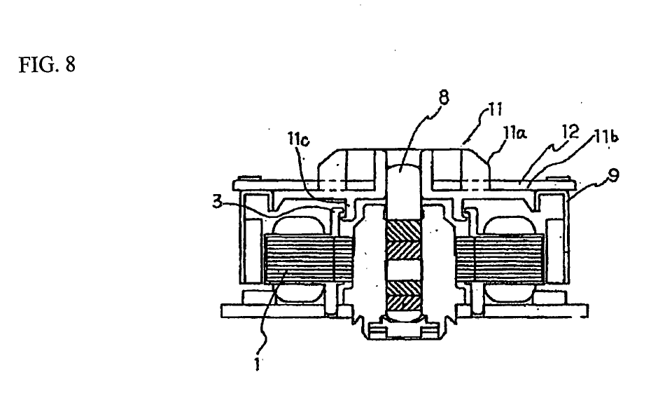

### DETAILED DESCRIPTION OF THE PREFERRED EMBODIMENTS

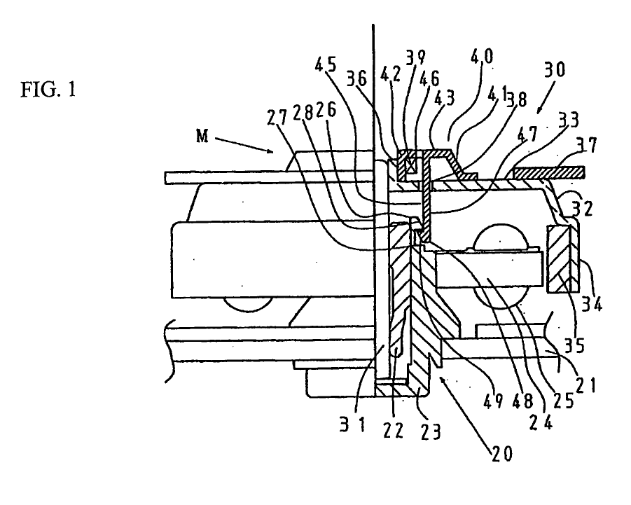

The preferred embodiment of the spindle motor in accordance with the present invention will be described hereinbelow with reference to FIGS. 1 through 7.

Referring to FIG. 1, a spindle motor M is composed of a stator 20 and a rotor 30.

The stator 20 comprises a plate-like stator base 21, a tubular bearing housing 23 having a bearing 22 installed inside thereof, a core 24 fixed to this bearing housing 23, and a coil 25 mounted on the core 24. The structure of the stator 20 is identical to the conventional structure, with the exception of the below-described latching portion 26, and the explanation thereof will be omitted.

The rotor 30 is the so-called outer rotor in which a rotor yoke 32 that is a magnetic body is fixed to a rotary shaft 31. The rotor yoke 32 is formed to have a cup-like shape in which a hollow cylindrical body 34 is provided on the circumference of a disk-like flat portion 33. A magnet 35 is mounted on the entire periphery inside the body 34.

A barring portion 36 protruding upward as shown in FIG. 1 is provided in the center of the flat portion 33. The rotary shaft 31 is fixed by press fitting, adhesively bonding, or welding by using the barring portion 36. This barring portion 36 may also protrude downward.

As for a method for fixing the rotary shaft 31 and rotor yoke 32, they can be also fixed via a bushing made from brass or the like.

A disk carrying surface is formed at the rotor yoke by using the flat portion 33. For example, a ring-like sheet 37 made from a rubber is pasted on the outer peripheral potion of the flat portion 33 to prevent the disk from slipping.

A cap 40 made from a resin and positioning the disk on the spindle motor M is mounted in the central portion of the rotor yoke 32. The cap 40 has an almost conical shape having a taper portion 41 for guiding a mounting hole provided in the center of the disk, comprises a magnet 39 for attracting a clamp (not shown in the figures) for disk chucking, and is mounted by press fitting a cylindrical fixing portion 42 provided in the center into the barring portion 36 of the rotor yoke 32.

In addition to the above-described methods, a variety of other methods such as latching with a hook-like member or mounting with an adhesive can be considered for mounting the cap 40 on the rotor yoke.

A plurality of hooks 45 are provided concentrically around the rotary shaft 31, those hooks constituting a locking structure which is a specific constituent feature of the present application. When the cap 40 is mounted on the rotor yoke 32, the hooks 45 are disposed on the inner side of the rotor 30 through the insertion holes 38 provided in the rotor yoke 32.

One hook may be provided, but because the cap size differs depending on, for example, the disk type, the appropriate number of hooks is determined according to this size. The hooks 45 are molded from a resin integrally with the cap 40.

A hook 45 is composed of a foot portion 47 and a mating catch 48 provided at the distal end thereof. A projection 49 is provided at the inner side of the mating catch 48. The projection is employed for contactless engagement with the latching portion 26 provided in the vicinity of the upper end of the bearing housing 23.

The latching portion 26 is composed of a groove 27 formed along the entire periphery in the vicinity of the upper end portion of the bearing housing 23 and a taper portion 28 for smoothly engaging the mating catch 48 with the groove 27. The mating catch 48 is engaged by the projection 49 thereof entering the groove 27 without contact with the bearing housing 23.

The latching portion 26 may be formed directly in the bearing housing 23, as in the present embodiment, or the resin latching portion may be formed as a separate member and mounted on the bearing housing 23 or core 24.

A through hole 46 is formed in the top surface 43 of the cap 40 and the root portion of the hook 45. This hole serves to form the projection 49 of the mating catch 48 provided at the distal end of the hook 45.

When a shape such as that of the resin cap 40 is fabricated by injection molding, the configuration of the mold used for such molding is typically such that the side of the top surface 43 serves as a cavity and the side of the mating catch 48 serves as a core. When a shape such as that of the projection 49 of the mating catch 48 is provided, a sliding mold can be also used, but it is preferred that the mold configuration be as simple as possible. There is a comparatively high degree of freedom in selecting the shape of top surface 43 of the cap 40, and even forming a through hole in this portion poses no problem. Accordingly, a protruding pin is provided from the cavity side to the projection 49 and the mating catch 48 is formed without fabricating a sliding mold.

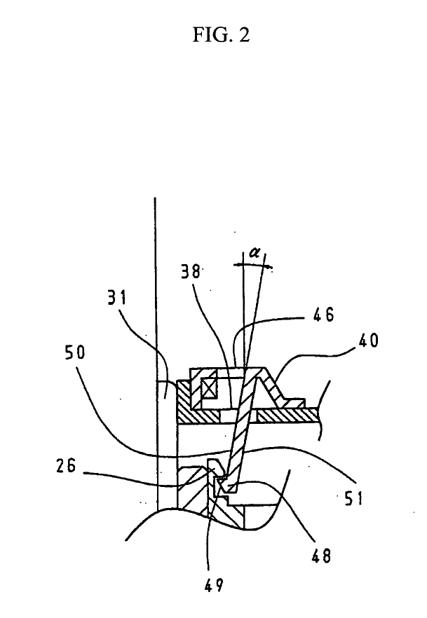

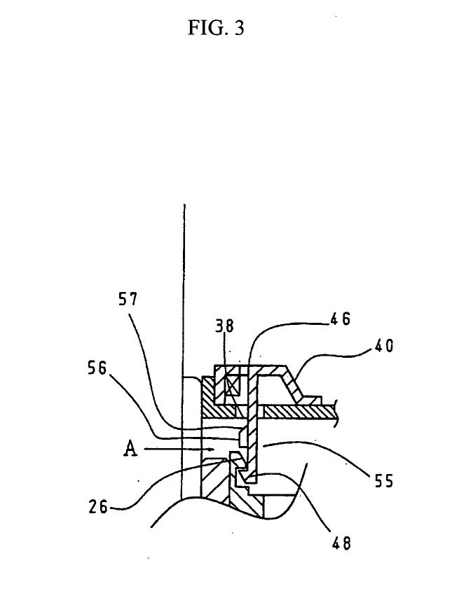

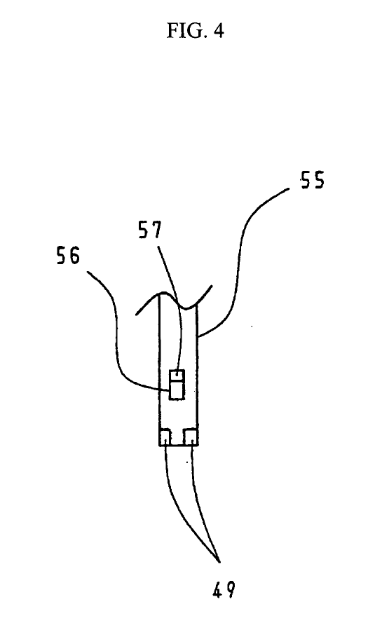

FIG. 2 and FIG. 3 are enlarged views of a hook 50 and a hook 55 which illustrate other embodiments of the hook 45. FIG. 4 is a view of the hook 55 shown in FIG. 3, this view being taken as shown by an arrow A.

Components identical to those in FIG. 1 are assigned with same symbols and explanation thereof is omitted.

Referring to FIG. 2, a foot portion 51 of the hook 50 is formed with inclination toward the latching portion 26 at the prescribed angle of a degrees with respect to the rotary shaft 31. The through hole 46 in this case is formed so that it enlarges inwardly according to the inward inclination of the foot portion 51, in view of the mold configuration.

On the other hand, if the insertion hole 38 is formed so that the projection 49 of the mating catch 48 passes therethrough, using elasticity of the foot portion 51 makes it unnecessary to install the foot portion 51 with a large inclination.

The hook 55 shown in FIG. 3 is not inclined with respect to the gap 40, similarly to the hook 45, but a protruding portion 56 having a taper portion 57 is provided at the rotary shaft 31 side of the hook. The protrusion degree of this protruding portion 56 is set equal to or somewhat less than that of the projection 49 and the protruding portion is formed to have a width equal to the gap between the split projections 49, as shown in FIG. 4.

With such a shape, it is unnecessary to provide a mold for forming the cap 40 with a sliding structure, similarly to other embodiments.

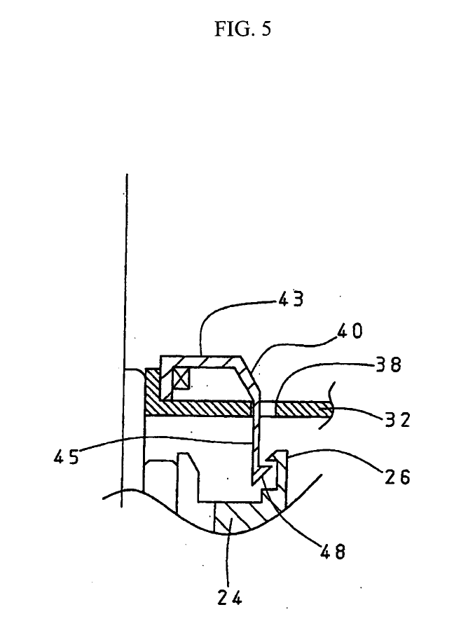

FIG. 5 shows an example in which the hook 45 is formed on the circumference of the cap 40, and the projection 49 of the mating catch 48 is formed outwardly.

If the cap 40 is formed in the above-described manner and the latching portion 26 is formed on the core 24 of the stator 20, it is not necessary to provide the mold with a sliding shape and to provide a through hole 46 in the cap 40. Therefore, the mold structure can be further simplified. Moreover, the possibility of forming freely the shape of the top surface 43 of the cap 40 is advantageous in terms of strength and precision.

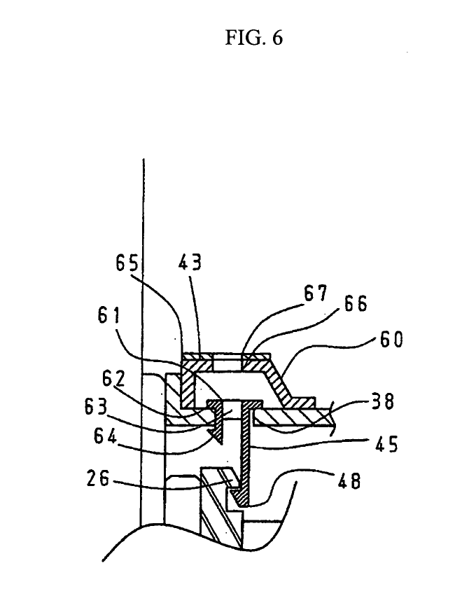

FIG. 6 shows a configuration in which a cap and a hook are provided separately, this configuration representing yet another embodiment.

A latching member 61 formed separately from the cap 60 is installed in the insertion hole 38 of the rotor yoke 32. The latching member 61 is composed of a hook 45, a mounting catch 64, and a collar 62 for fixing the base portions thereof. The collar 62 has a shape allowing it to hang around the insertion hole 38.

The latching member 61 is fixed in the insertion hole 38 of the rotor yoke with the collar 62 and the mounting catch 64.

A magnetic plate 65 for clamp attraction is fixed to the top surface 43 of the cap 60, and through holes 66, 67 are provided in identical locations in the top surface 43 and magnetic plate 65.

A through hole 63 is provided at the root portion of the hook 45 and the mounting catch 64.

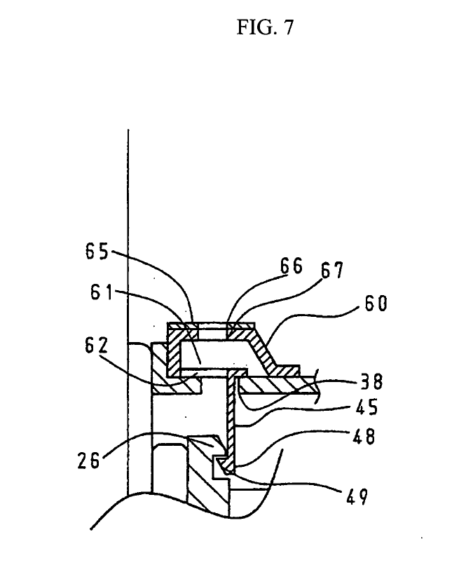

FIG. 7 shows an example in which a plurality of latching members 61 are provided on the rotor yoke. When a plurality of latching members 61 are provided concentrically with respect to the rotary shaft 31, if the latching members 61 are connected to each other with the collar 62, the mounting catch 64 is unnecessary for fixing those latching members 61 integrally in the insertion hole 38. In this case, the hook 45 can be operated from the insertion hole 38, without providing the special through hole 63 therefor.

In this case, too, the mounting location of the latching member or the mating catch 48 may be directed outwardly.

In order to separate the rotor 30 from the stator 20 in the motor M of the above-described configuration, a thin screwdriver or shaft is inserted from the through hole 46 and through the insertion hole 38 and the rotor 30 is pulled away from the stator 20 by elastically deforming the hooks 45, 50, 55, while pushing and bending them in the direction of withdrawal from the groove 27.

If the size of the through hole or insertion hole is set at about the size of the mating catch 48, the unnecessary large bending of the hooks 45, 50, 55 can be avoided and deformation and fracture of the hooks is prevented.

In the embodiment shown in FIGS. 6 and 7, a thin screwdriver or shaft is caused to move into the through hole 46 (insertion hole 38) via through holes 66, 67 provided in the magnetic plate 65 and cap 60.

The operation of elastically deforming the hooks 45, 50, 55 in the direction of withdrawal from the groove 27 makes it possible to separate easily the rotor 30 from the stator 20. Furthermore, because unnecessary pulling is avoided, fracture of the latching portion 26 and hooks 45, 50, 55 is prevented.

Here, if the foot portion 51 is inclined, as in the hook 50, toward the rotary shaft at the prescribed angle, then the mating catch 48 can be elastically deformed and withdrawn from the groove 27 by merely introducing a screwdriver or shaft from the through hole 46, without pressing the hook 50 in the lateral direction with respect to the rotary shaft 31, and the operations are further facilitated.

Providing a protruding portion 56, as in the hook 55, and bringing a driver or shaft into contact with the protruding portion 56, while guiding it with the taper portion 57 of the protruding portion, makes it possible to withdraw the mating catch 48 from the groove 27, in the same manner as in the case of hook 50, and to separate the rotor 30 easily from the stator 20.

Furthermore, in the configuration of the present embodiment, the rotor yoke 32 is fixed to the rotary shaft 31 and the latching member 61 and the cap 40 having the hooks 45, 50, 55 formed therein are mounted on the rotor yoke 32. Therefore, even if the hooks 45, 50, 55 are broken, only the cap 40 and the latching member 61 have to be replaced on the rotor yoke 32 and it is not necessary to discard the rotor 30 which is the main component constituting the motor M.

Furthermore, the cap 40 composed of a resin has an almost conical shape and was used as a disk positioning jig. However, it is also possible to extend the resin part to the disk-like flat portion 33 and to form the disk carrying portion integrally.

The same effect can be also obtained by providing the above-described disk carrying portion and cap 40 made from resin as separate components and integrating the disk carrying portion and the latching member.

In the present embodiment explained with reference to the appended drawings, the projection 49 was formed toward the rotary shaft 31. However, it may be also directed from the rotary shaft 31, that is, to the outside, and the latching portion 26 provided on the bearing housing 23 may be formed on the core. In this case, the through hole 46 is formed on the outer side of the hooks 45, 50, 55.

Furthermore, in the configuration shown in FIGS. 6 and 7, the latching member 61 was positioned below the cap 60, but it may be also positioned on the outside of the cap 60 in the flat portion of the rotor yoke 32. With such positioning, it is not necessary to provide through holes 66, 67 in the cap 60 and magnetic plate 65, the degree of freedom in selecting a shape is increased, only the latching member may be replaced when the mating catch 48 is broken, and the cap is not wasted.

FIG. 1

M MOTOR

20 STATOR

26 LATCHING PORTION

27 GROOVE

28 TAPER PORTION

30 ROTOR

36 BARRING PORTION

38 INSERTION HOLE

40 CAP

45 HOOK

46 THROUGH HOLE

48 MATING CATCH

What I claim is:

1. The combination for a spindle motor comprising:
a rotor including a yoke,
said yoke having a disk section having an opening,
a locking part on said disk section,
said lockable part having an extending catch passing through said opening,
a stator having an engageable part which is adapted to engage said catch to preclude separation of said rotor from said stator,
said opening being positioned to form an access opening providing access to said catch to enable disengagement of said catch from said engageable part of said stator to facilitate disassembly of said rotor and said stator.

2. The combination according to claim 1, wherein said catch has an elongate section which is flexible, said elongate section being flexed to a flexed state to effect disengagement of said catch from said engageable part of said stator.

3. The combination according to claim 1, wherein said lockable part is formed separately from said yoke.

4. The combination according to claim 1, wherein said yoke is a magnetic body and said lockable part is made of a resin material.

5. The combination according to claim 1, wherein said rotor includes an outer cylindrical section which together with said disk section forms at least a partial enclosure for said stator, said catch extending into said enclosure, said opening providing access to said catch within said enclosure from outside of said enclosure.

6. The combination according to claim 1, wherein said rotor assembly comprises a rotor shaft, said yoke being fixedly mounted on said rotor shaft.

7. A spindle motor comprising:
a motor shaft,
a stator disposed about said shaft,
a rotor mounted on said shaft,
said rotor having a rotor yoke,
a first lockable part on said rotor yoke, said rotor yoke having a section defining an opening through which said first lockable part extends,
said stator having a second lockable part lockable with said first lockable part to effect a locking relationship between said rotor and said stator,
said opening being located on said rotor yoke section in a position to enable access through said opening to said first lockable part to effect unlocking of said rotor and said stator.

8. A spindle motor according to claim 7, wherein said first and second lockable parts have a lockable state and an unlockable state, said first lockable part having a flexible section having a flexed state, said first lockable part being in said unlockable state when said flexible section is in said flexed state.

9. A spindle motor according to claim 8, wherein said first lockable part is spaced from said second lockable part when said first and second lockable parts are in said lockable state.

10. A motor comprising:
a stator assembly,
a rotor assembly rotatably mounted relative to said stator,
said rotor assembly having a rotor yoke with a flat section,
said flat section having a portion defining an opening,
a first lockable part on said rotor yoke,
said first lockable part having an extending section and a first catch section,
said extending section and said first catch section extending through said opening,
said stator assembly having a second catch section mateable with said first catch section to effect locking of said rotor and stator assemblies,
said opening being located on said flat section of said rotor yoke to enable access to said first catch section to enable unlocking of said rotor and stator assemblies.

11. A motor according to claim 10, wherein said opening enables passage of said first catch section through said opening to facilitate disassembly of said rotor and stator assemblies.

12. A motor according to claim 10, wherein said rotor assembly is rotatable about an axes of rotation, said first catch section having an engageable surface disposed perpendicular to said axis of rotation.

13. A motor according to claim 12, wherein first catch section has a face disposed at an acute angle relative to said axis of rotation.

14. A motor according to claim 10, wherein said rotor assembly rotates about an axis of rotation, said extending section of said first lockable part having an elongate axis extending at an acute angle relative to said axis of rotation.

15. A motor according to claim 10, wherein said extending section of said first lockable part has a lateral projection accessible through said opening to facilitate unlatching of said rotor and stator assemblies.

16. A motor according to claim 10, wherein said first and second catch sections have engageable surfaces which preclude unlocking of said first and second catch sections, said engageable surfaces being spaced from one another during operation of the motor.

17. A motor according to claim 16, wherein said rotor assembly as rotatable about an axis of rotation, said engageable surfaces being perpendicular to said axis of rotation and being superimposed relative to one another.

18. A motor according to claim 10, wherein said first lockable part and said opening are aligned so that an implement is insertable through said opening to engage said first lockable part and thereby release said first catch section from said second catch section.

19. The combination according to claim 10, wherein said first lockable part has an insertion section inserted into said opening and a collar disposed on said flat section of said rotor yoke.

20. The combination according to claim 10 further comprising a mounting for mounting said first lockable part on said rotor yoke.
